(19) United States
(12) Patent Application Publication
(10) Pub. No.: US 2022/0005050 A1
(43) Pub. Date: Jan. 6, 2022

(54) MEDIA POST INTERFACE SYSTEM AND METHODS OF USE

(71) Applicant: TAPTEN INC., Miami, FL (US)

(72) Inventor: Mildred Maria Villafane, Lomas de Chapultepec (MX)

(21) Appl. No.: 17/477,454

(22) Filed: Sep. 16, 2021

Related U.S. Application Data
(63) Continuation-in-part of application No. 16/273,063, filed on Feb. 11, 2019.
(60) Provisional application No. 63/079,190, filed on Sep. 16, 2020.

(51) Int. Cl. G06Q 20/42; G06Q 50/00; G06Q 20/32

(52) U.S. Cl. CPC G06Q 20/42; G06Q 20/326; G06Q 50/01

(57) ABSTRACT

The technology described herein relates to social media platform posts that are configured by a media post creator to provide for a selectable action by a post viewer. The action relates to one or more subjects contained in the post. When the post viewer selects the action from a media post, the viewer can procure one or more items associated with the action. The action is configured so that a user initiating the action can procure an item without having to navigate to a non-platform site that makes the item available. Furthermore, post actions can be configured to allow a user to select items from multiple vendors and checkout without leaving the platform. The user only has to perform checkout actions once, even when procuring multiple items from multiple sites.

### CROSS-REFERENCE TO RELATED APPLICATION

This application claims priority to U.S. Provisional Patent Application No. 63/079,190 filed on Sep. 16, 2020 and entitled “Configuring Links in User Created Content.” This application is a continuation-in-part of U.S. patent application Ser. No. 16/273,063 filed on Feb. 11, 2019 and entitled “User Created Content Referral and Search.” The entireties of each of the applications identified above are incorporated by reference herein for all purposes, to the extent that no conflict exists between said applications and the statements and drawings set forth herein. If such a conflict exists, the usage of this document controls.

### BACKGROUND

The popularity and evolution of mobile technology and services offered through mobile phones has enabled manufacturers and application developers to bring a great range of possibilities to the market with more features and more power for relatively low prices. The result has been that, over the last several years, mobile phones have become a common and indispensable possession for people around the world. With this tool at their disposal, people are using mobile phone applications such as Google®, Facebook®, Instagram®, Pinterest®, TikTok®, and the like, in record numbers to create content that they share with other users. Such content includes images, text, videos, links, audio, etc. that are of interest to a user creating a post.

Currently there is no way for a content creator (i.e., a creator of a media post) to provide a way for another user to easily access direct actions from a post other than providing actionable links in the post or a link to a map. Such links can take users away from their media application to a third-party site associated with the links, which may not be desirable for the users, the media application, product providers, and the like.

### BRIEF DESCRIPTION OF THE DRAWINGS

The Detailed Description, below, makes reference to the accompanying figures. In the figures, the left-most digit(s) of a reference use of the same reference numbers in different figures indicates similar or identical items.

FIG. 1 is a representation of a smart phone depicting a user interface utilized in the techniques presented herein, the user interface for creating a content referral.

FIG. 2 is a representation of a smart phone showing an example user interface depicting a first action assignment view state of an action assignment process.

FIG. 3 is a representation of a smart phone showing an example user interface depicting a second action assignment view state of an action assignment process.

FIG. 4 is a flow diagram that depicts a process for adding an action item to a content referral for posting.

FIG. 5 is a block diagram of an example phone that may be used to implement the presently described techniques.

FIG. 6 is a block diagram of an example server that may be used to implement the presently described techniques.

FIG. 7 is diagram depicting additional details of the action creation process generally described with respect to FIGS. 1-4, as well as an API generation process.

FIG. 8 is a diagram depicting a process associated with creation of a cart associated with a user and with one or more products selected for purchase by the user.

FIG. 9 is a diagram depicting a process associated with a final checkout by a user who has selected items for purchase.

FIG. 10 is an illustration of an example phone interface configured to enable a user to purchase an item using a single click.

FIG. 11 is an illustration of an example phone interface showing a shopping cart containing products from multiple providers.

### DETAILED DESCRIPTION

The technology described herein relates to interfaces used in media posts to create and communicate with an action that has been included in a media post by a creator to the post. As used herein, the term “action” or “action item” refers to a process associated with a media post, wherein a viewer of the post can actuate an icon to execute the process to perform a task. As used herein, the term “media post” or “post” refers to content that a user creates and uploads to a network and/or an application, such as a social media application. Some terms used herein are defined in the parent application, U.S. patent application Ser. No. 16/273,063 entitled “User Created Content Referral and Search,” referenced above and incorporated herein. If there is a conflict of terms between the present application and the parent application, terms as defined in the present application shall control. To clarify the present discussion, the term “User 1” as used herein refers to a user who creates a content referral in the systems defined herein and in the parent application, and who may execute an action creation process to add one or more procurement items (e.g., products, services, tickets, reservations, etc.) to their content referral prior to posting their content referral. “User 2” is used herein to refer to a user who views a posted content referral (i.e. a “post”) and who may select an action icon to execute the action process(es) to procure a listed item. After User 1 creates and posts a content referral that includes an action item, User 2 can actuate an icon associated with the action item to access and select one or more procurement items. Although the present discussion refers to “content referrals,” the presently described techniques may be used with any type of known system or process for posting content.

One particular advantage of the techniques described herein is that a user can procure a procurement item without having to leave the trusted content referral system platform and go to a different site to complete a purchase or procurement. The user can provide information to the platform and the platform will provide information needed to complete the procurement. In at least one implementation, a user stores shipping and payment information in the system and may purchase an item by simply clicking a “purchase” icon without going through a typical shopping cart process. In this way, actions are more than simply a link embedded in a post, which is a common way for platforms to provide access to particular procurement items to users.

Similarly, the present techniques can be used to provide a user a way to purchases goods/services from multiple sites without having to enter personal or payment information for each site or to transfer to any of the multiple sites. This provides the advantage of reducing user and computer resources to visit individual sites and enter information at each site.

In addition to the foregoing, the present techniques also provide a feedback and learning mechanism whereby the system monitors creation and completion of APIs and learns how to assist users and in the API creation process.

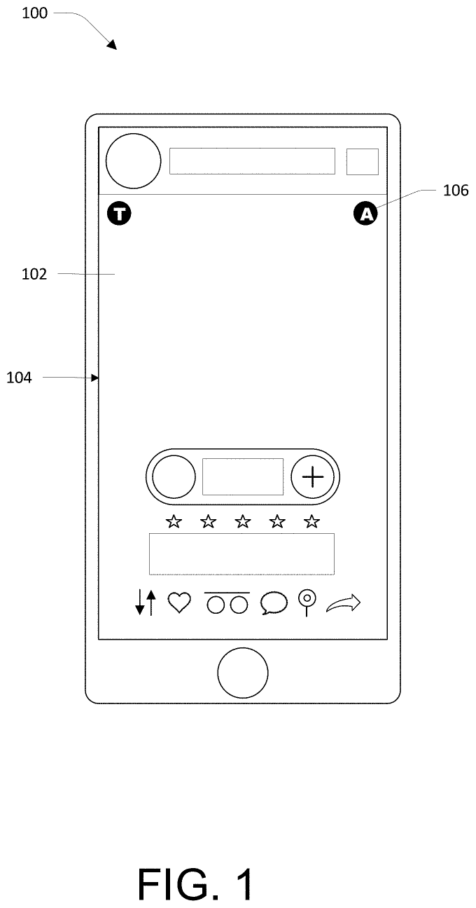

Other benefits and advantages of the described techniques will be clear to a person having ordinary skill in the art in light of the technological advancements of the systems and methods described herein with reference to corresponding FIGS. 1-11.

### Content Referral System: Action Creation User Interface

FIG. 1 is a representation of a smart phone 100 that depicts an example user interface 102 that is used to create an action in a content referral system as described in the parent of the present application. The smart phone 100 includes a display 102 shown displaying a user interface 104 from which User 1 can add an action to a content referral created by User 1. The user interface 104 includes an action icon 106 that is selectable by User 1 to initiate the action creation process(es) described herein. Continuing reference will be made to FIG. 1 and the elements contained therein throughout the present description to describe features of the claimed techniques.

### Action Assignment: First Action Assignment View

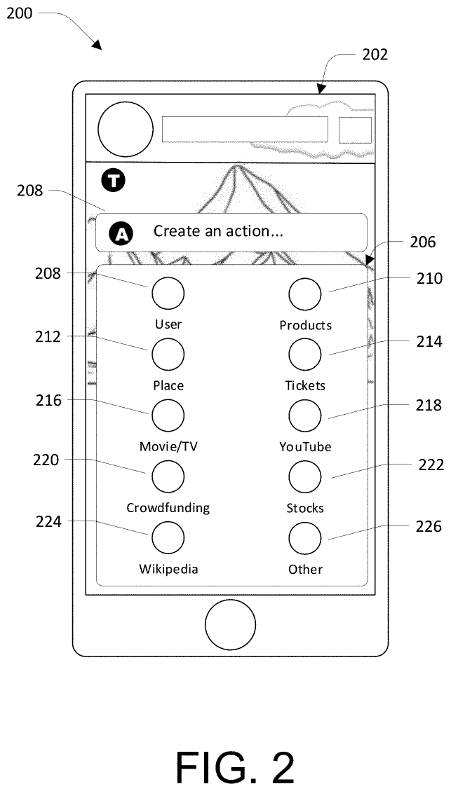

FIG. 2 is a representation of a smart phone 200 showing an example user interface 202 that depicts a first action assignment view of an action assignment process. After User 1 selects the action icon 106 (FIG. 1), User 1 is presented with the user interface 202 shown in FIG. 2. The user interface 202 includes a first dialog box 204 that identifies the user interface 202. The user interface 202 also includes a second dialog box 206 that displays a number of different types of actions (or action categories) that can be associated with the content referral created by User 1. As shown in the present example, the user interface 202 includes a number of selectable action icons 208-226. A selectable icon is associated with a particular type of procurement item that is selected and associated with a content referral.

As shown in FIG. 2, the following selectable action icons are shown:
User action icon 208: an action that adds a user contact or profile to an action and is used to go directly to a user profile, where another action may be performed, such as contacting the user, acquiring a coupon associated with the user, contacting the user associated with the user profile, schedule an appointment or service with the user, etc.;
Product action icon 210: an action that displays one or more products associated with a subject matter of a content referral;
Place action icon 212: enables User 1 to add information about a specified place (restaurant, etc.), dial a phone number specified in an action, etc.;
Tickets action icon 214: an action that enables User 2 to view/purchase tickets for an event;
Movie/TV action icon 216: an action that takes User 2 directly to one or more movies or television shows that are related to the subject matter of a content referral, e.g., “True Detective,” etc.
YouTube® action icon 218: obtains a video available on YouTube®;
Crowdfunding action icon 220: obtains information and interacts with and executes a crowdfunding source procurement process;
Stocks action icon 222: allows User 2 to view and purchase equities;
Wiki action icon 224: retrieves information from a public site (in this case) for User 2;
Other action icon 226: used either to provide a secondary list of action items available to User 1, or to create a custom action item.

Continuing reference will be made to FIG. 2 and the elements contained therein throughout the present description to describe features of the claimed techniques.

### Action Assignment: Second Action Assignment View

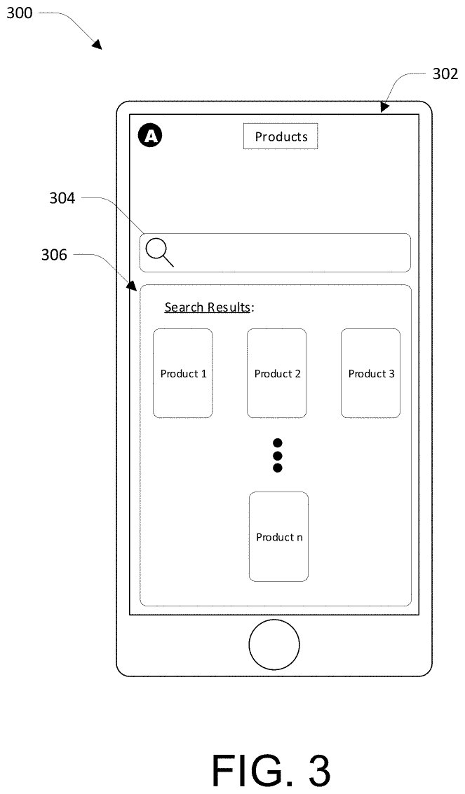

FIG. 3 is a representation of a smart phone 300 showing an example user interface 302 that depicts a second action assignment view of an action assignment process. The user interface 302 includes a search dialog box 304 and a search results dialog box 306. When creating a product action item (the present example is related to an action that features a product), User 1 enters a search term in the search dialog box 304 so that User 1 can locate one or more providers that sell a product shown in a content referral. The search results from such a search are shown in the search results dialog box 306. User 1 may then select one or more of the products shown in the search results dialog box 306 to add information to an action that enables User 2 to select a product and procure the product using the techniques described herein.

Continuing reference will be made to FIG. 3 and the elements contained therein throughout the present description to describe features of the claimed techniques.

### Action Assignment Methodological Implementation

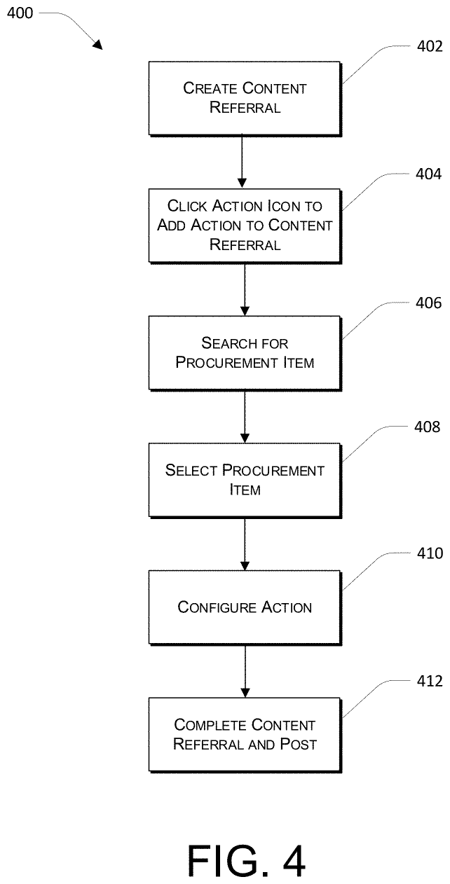

FIG. 4 depicts a flow diagram 400 that depicts a process for adding an action item to a content referral for posting. The following discussion of FIG. 4 refers to one or more previous figures using the same description and reference numerals associated therewith.

At step 402, User 1 begins the process to create a content referral. The content referral process is described in detail on the parent application hereto. At step 404, User 1 clicks on the action icon 106 (FIG. 1) to initiate a process for adding an action to the content referral. At step 406, User 1 searches for a procurement item (e.g. a product, a service, etc.) to include in the content referral and selects one or more appropriate procurement items at step 408. At step 410, User 1 configures the action as further described herein below. When the action has been completed, User 1 completes creation of the content referral and posts the content referral at step 412.

### Actionable Post Checkout Container System—Phone

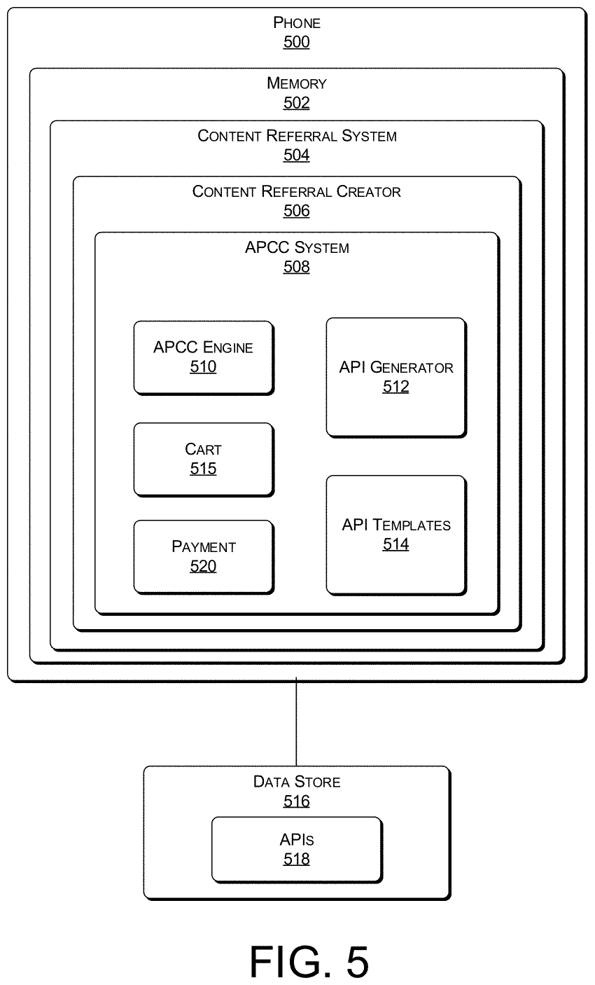

FIG. 5 is a block diagram of an exemplary phone 500 that may be used to implement the present techniques. The exemplary phone 500 includes at least memory 502 in addition to other operational hardware element not shown. A content referral system 504 is stored in the memory 502 and includes modules necessary to implement content referral creation and usage as described in the parent application. The content referral system 504 includes a content referral creator 506, which includes an APCC (Action Post Checkout Container) system 508. The APCC system 508 includes an APCC engine 510 and an API generator 512. If a provider does not have a developed API for their product(s), the API generator 512 assists the provider to develop an API for use with the system, the API conforming to the system protocols and containing information particular to the provider. The APCC system 508 also stores multiple API templates 514, each API template being associated with a particular type of procurement item (product, event, reservation, etc.). The APCC system 508 also includes a cart 515 that stores items selected for purchase by a user. A data store 516, which may be included on the example phone 500 or a server (not shown) stores multiple APIs 518 generated by the APCC system 508 by techniques describe in greater detail below. The APCC further includes a payment module 520 that works in conjunction with the cart 515 to determine payments to providers, users, platform, etc. The payment module 520 is described in greater detail below.

### Actionable Post Checkout Container System—Server

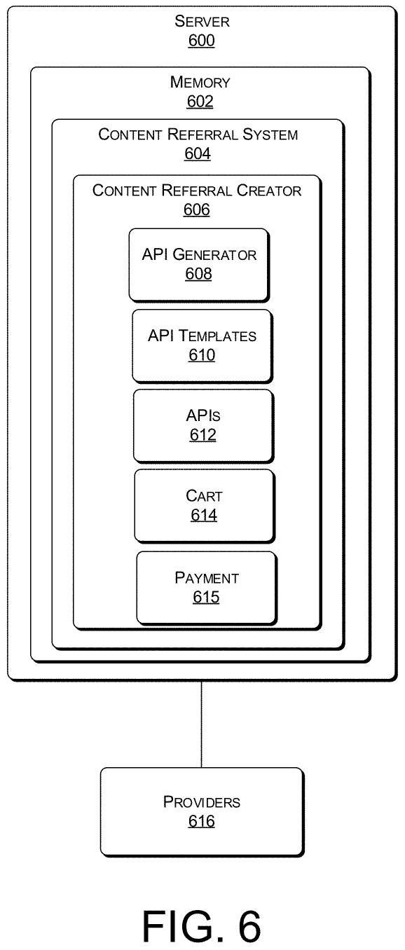

FIG. 6 is a block diagram of an exemplary server 600 that may be used to implement the techniques described herein. The exemplary server 600 includes at least memory 602, which stores a content referral system 604. The content referral system 604 includes an APCC system 606. The APCC system 606 includes an API Generator 608, multiple API templates 610, and stores multiple APIs 612. The APCC system 606 also includes a cart 614 that stores items selected for purchase by a user. The APCC further includes a payment module 615 that works in conjunction with the cart 614 to determine payments to providers, users, platform, etc. The payment module 615 is described in greater detail below. FIG. 6 also shows multiple providers 616 that interact with the server 600. The elements and functionality of FIG. 6 are described in greater detail below.

### APCC Creation

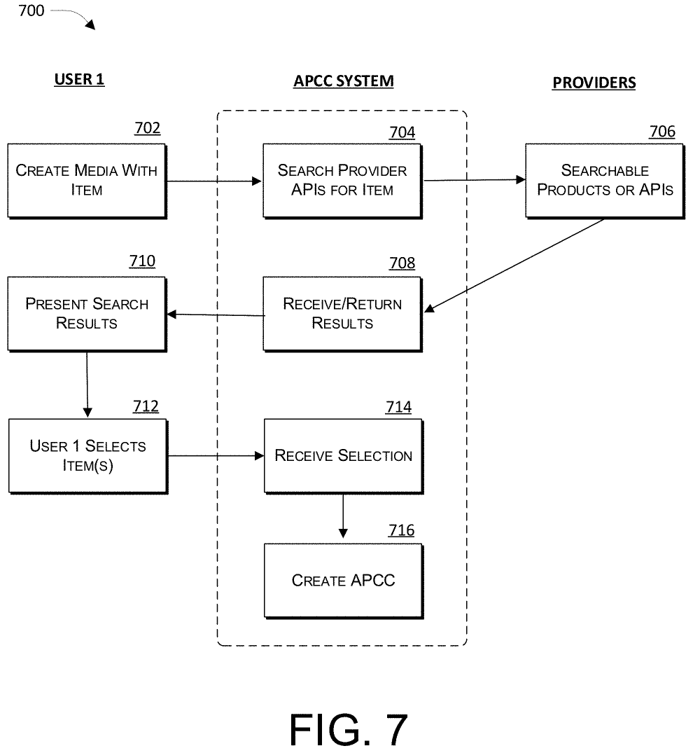

FIG. 7 is a diagram 700 depicting additional details of the action creation process generally described with respect to FIGS. 1-4. The following description of FIG. 7 refers to one or more previous figures, using similar element names and reference numerals. In the following example, the description relates to a product chosen by User 1 to relate to his action item. In other examples, User 1 may select a different type of procurement item, such as an event, a reservation, an appointment, etc.

At 702, User 1 creates a content referral with selected media and invokes the action creation process. At 704, the APCC engine 510 (FIG. 5) invokes a search for possible procurement item APIs to include in the content referral, searching for APIs representing matching products. At this point, the APCC engine can also search pre-populated provider APIs to determine if an API for a matching product from the provider has already been created and stored (514, 612). At 706, the providers having an item that matches the search criteria or a pre-loaded API returns necessary matching item information (provider id, product id, keywords, etc.) to the APCC engine, which receives the results (708) and presents the results to User 1 (710). In addition to basic information, the provider, through an API with the APCC system, may also provide other relevant information such as coupons, promotions, tax information, etc.

At 712, User 1 selects one or more items from the displayed items and the selection is received at 714. At 716, the APCC engine 510 creates an APCC that is associated with the content referral and post of User 1. Also at 716, the APCC engine 510 may send and store user psychographics, demographics, behavioral data, etc. to the API generator 512. Such data may update certain aspects of the APCC engine 510 to use for future reference in assisting providers select and create efficient APIs through the API generator 512. And for future posts and content suggestions for User 1 and User 2 from platform.

An example API template for a product is shown below:
Class: Item
Methods:
   Get item:
      Inputs:
         Vendor ID
         Item ID
   Find item:
      Inputs:
         Vendor ID
         Item Name
         Keywords
      Outputs:
         List of Vendor item IDs

Other procurement items, such as event tickets, reservations, stocks, etc. may have a unique API associated with them to accommodate the various information that is required for each type of procurement item. For example, an API associated with a restaurant reservation may not require an Item ID like an API associated with a product might. Each type of procurement item may have its own unique API.

In one or more implementations, providers (of products, services, etc.) may store API templates to be used with purchases from their store. Such API templates can be pre-populated with provider information to expedite the API creation process. In such cases, rather than populate a blank API template, the API generator 512 identifies the pre-existing provider API template and populates it with additional information. In yet other implementations, providers may store a fully-populated API associated with each product made available by the provider. In such cases, the API generator only has to retrieve an API that is associated with a selected product.

### Checkout Process: Cart Creation/Updates

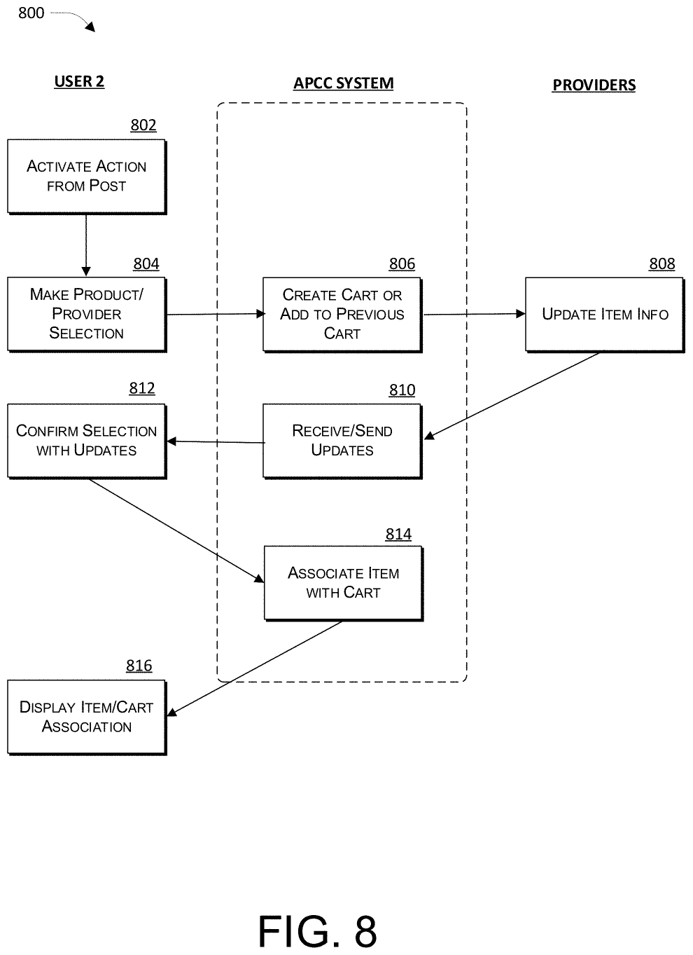

FIG. 8 is a diagram 800 depicting a process associated with creation of a cart associated with User 2 and with one or more products selected for purchase by User 2. The following description of FIG. 8 refers to one or more previous figures, using similar element names and reference numerals. In the following example, the description relates to a product for purchase chosen by User 2 from a post made by User 1. In other examples, User 1 may select a different type of procurement item, such as an event, a reservation, etc.

At 802, User 2 activates the action icon 106 (FIG. 1) from a post containing a content referral (created by User 1). Upon selection of an item to purchase at 804 (selecting the item and the provider of the item), the APCC system 508 creates a cart or associates the selected item with an existing cart that is associated with User 2 at 806. As explained in greater detail below, the cart may contain items from different providers, enabling User 2 to place an item from a first provider in the cart and continue shopping, ultimately placing a second item in the same cart. The APCC system 508 verifies item information—such as availability, pricing, etc.—at 808 and updates information if necessary. The verified/updated information is received by the APCC system 508 at 810 and it is transmitted to User 2 at 812, so that User 2 can view the verified/updated product info and decide to continue or cancel the transaction. If User 2 confirms the purchase, then the item is associated with the cart at 814. User 2 then receives confirmation that the item is in a cart and ready for checkout.

It is noted that User 2 may continue to add items to the cart, even if additional items are available from a different provider. In this way, User 2 can collect multiple items from multiple providers in his cart. As is described in greater detail below, when User 2 checks out, he can simply go through a single process where User 2 personal information and payment information is provided to the APCC system. The APCC system, as shown below, then provides necessary information to each vendor to procure the items.

If User 2 wants to modify the cart (515, 614) after it has been created, User 2 activates a cart icon to display the cart contents. User 2 can then delete one or more items from the cart, or update a product in the cart, such as a quantity, color, etc. When User 2 takes such an action, the APCC system (508, 606) returns to the provider of the updated product to check availability of a product that matches the updated product identified by User 2. The provider(s) sends updates to the APCC system, which relays the information to User 2. If the updated selection is unavailable, User 2 may elect to stay with the original item, update characteristics of the product (initiating a new update with the provider) or delete the product from the cart. By this manner, User 2 is assured that he is purchasing the product he wants and that it is available from a provider through the APCC system.

Example API templates related to a cart is shown below:
Class: Cart
Methods:
   Get cart
      Inputs:
         Customer id
         Cart id
   Create cart:
      Inputs (optional):
         Items
         Customer id
         Currency
         Vendor(s) id
      Outputs:
         Cart id
         Timestamp
   Delete cart:
      Inputs:
         Cart id
   Add item:
      Inputs:
         Item id
         Cart id
   Update Item
      Inputs:
         Item id
         Cart id
   Delete Item
      Items:
         Item id
         Cart id

### Checkout Process: Final Checkout

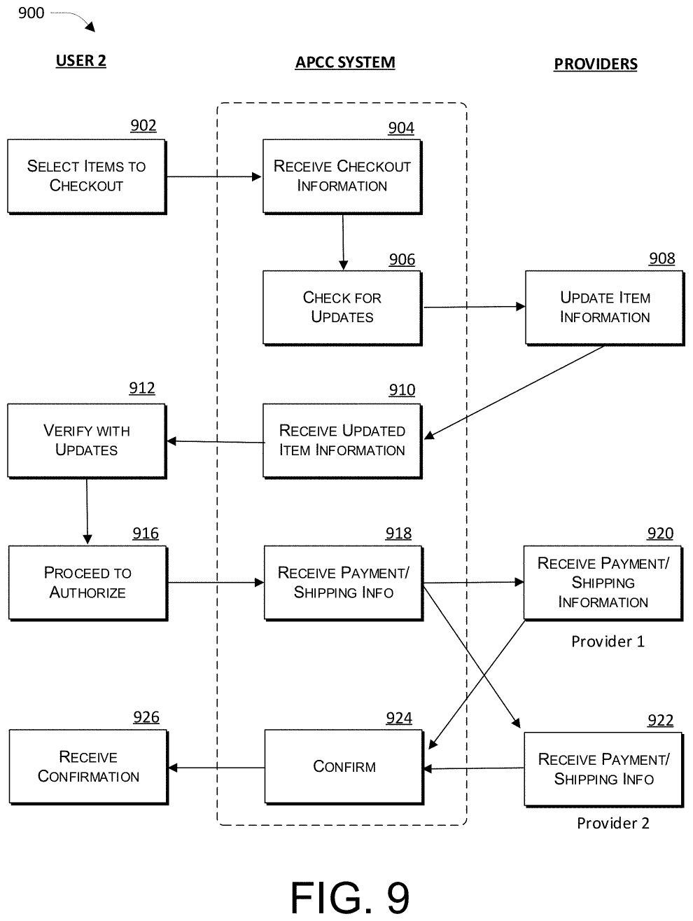

FIG. 9 is a diagram 900 depicting a process associated with a final checkout by User 2. The following description of FIG. 9 refers to one or more previous figures, using similar element names and reference numerals. In the following example, the description relates to two products in a cart created by User 2. In other examples, checkout may be for only a single item or for more than two items.

At 902, User 2 opens a previously created cart and selects items for which User 2 wants to proceed to checkout and finalize purchase. User 2 may select one or multiple items from the cart, depending on what User 2 is ready to purchase. This makes the cart system described herein similar to a wish list in that User 2 can hold items in his cart to purchase at a later date. The present example assumes User 2 selects two items from his cart for purchase. The two items may be from the same or different providers. At 904, the APCC system receives the selections and at 906, it checks for updates. An update is desirable at this time because it may have been some time since User 2 created the cart and logistics related to the selected items may have changed, such as availability, pricing, etc. At 908, the provider(s) update the information, including whether any credits are available to User 2 from promotions or the like. At 910, the APCC system receives the updated item info and passes it to User 2. At 912, User 2 verifies the updates and may elect to cancel the order (914) or to proceed to authorize the APCC system to continue with the purchase.

At 918, the payment module (520, 615) receives the information needed to complete the purchase, including payment data and shipping information. This information may be input by User 2 at this time, or it may be retrieved from the payment module if User 2 has previously stored such information. The APCC system (508, 606) then relays the payment/shipping information to a first provider (920) and to a second provider (922). The providers confirm the purchase at 924 and User 2 receives confirmation at 926.

In at least one alternate implementation, User 2 doesn't have to provide payment information to the providers. Instead, User 2 may elect to make the total payments to the APCC system directly which, in turn, provides payment to the providers. In this way, User 2's financial security is further protected by only having to provide payment credentials to one trusted entity. In this way, User 2 also saves a significant amount of time.

Example API templates related to a checkout is shown below:
Class: Checkout
Methods:
   Get checkout
      Inputs:
         Cart id
      Outputs:
         Checkout id
   Process checkout
      Inputs:
         Checkout id
         Payment id
         Vendor Access ids
      Outputs:
         Success
         Vendor Sale id
   Update checkout
      Inputs:
         Checkout id
         Addresses
         Coupons
         Gift certificates
         Store credits
         Payment methods
         Vendor access id
         Shipping
         Tax information
      Outputs:
         Success

### Monetary Incentives

One incentive contemplated by the techniques disclosed herein is to pay users (i.e. User 1) a commission when another user makes a purchase through the user's (User 1's) post. For example, if User 1 creates a post and adds an action item for Nike backpacks and User 2 purchases a Nike backpack by initiating the action item in User 1's post, an arrangement may be made whereby User 1 receives a portion of the purchase price of the Nike backpack purchased by User 2. Such an arrangement would contemplate the commission or incentive payment from the Content Referral system directly or from the provider from which User 2 purchased the backpack. Payments from providers to users may be made directly to users according to a pre-arranged agreement with providers and the Content Referral system. Or, the Content Referral system may have an agreement with providers to take a portion of the remitted payment for items and send it to the users. In such a case, the payment module stores commission information for each provider. When the system collects payment from User 2, it would provide appropriate amounts to the providers and to User 1. In an alternate implementation, such a commission is paid to the operator of the system as compensation. Such an arrangement could be made to reduce advertising on the platform or to maintain system operations.

### One-Click Purchase Option

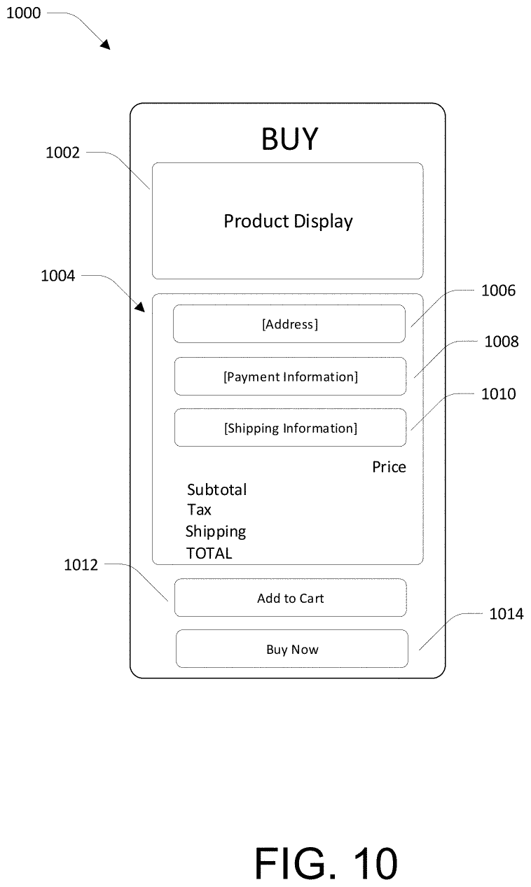

FIG. 10 is an illustration of an example phone interface 1000 configured to enable a user (User 2) to purchase an item using a single click. Using the techniques described herein, a user can purchase an item accessed by way of an action in a post and purchase the item without having to access a shopping cart or enter any relevant information (shipping and payment information).

The example phone interface 1000 includes a product display 1002 which displays a product (or other type of procurement item) made available when the user when the user clicks an action icon 106 (FIG. 1) in a posted content referral. The example phone interface 1000 also displays an information screen 1004, a purchaser address 1006, purchase payment information 1008, and shipping information 1010 together with pricing information. An “Add to Cart” button 1012 and a “Buy Now” button 1014 are provided on the example phone interface 1000.

When configuring a content referral post, a user (User 1) may select a single item that is available by way of the post. The example shown in FIG. 10 relates to a product, but User 1 might provide a service that is available in increments of one hour. When User 2 clicks on the action, User 2 is presented with the product display 1002. In such a case, there is no product search or shopping around—the proposal is a yes/no proposition.

If User 2 has pre-loaded and/or stored shipping and payment information into the system, that information is automatically loaded into the appropriate parts of the information screen 1004 and the appropriate price is calculated (with tax and shipping) and displayed. If User 2 wishes to purchase the product or other procurement item, User 2 can either add the product to a shopping cart by clicking the “Add to Cart” button 1012 or User 2 can proceed to purchase the product by clicking the “Buy it Now” button 1014. If User 2 selects the “Add to Cart” button 1012, then then a cart is created (or an existing cart is identified) and the product is added to the cart. User 2 may then continue to shop for other items or save the cart for a later use.

If User 2 simply wants to purchase the product and clicks the “Buy it Now” button 1014, then no cart is created (or an existing cart is bypassed), and User 2's information (address, payment info, shipping method) are provided to the provider selling the product shown in the product display 1002 and the product is purchased according to techniques described above. Utilizing the “Buy it Now” button 1014 thus saves User 2 time and effort in entering information to purchase the product.

### Shopping Cart—Multiple Providers

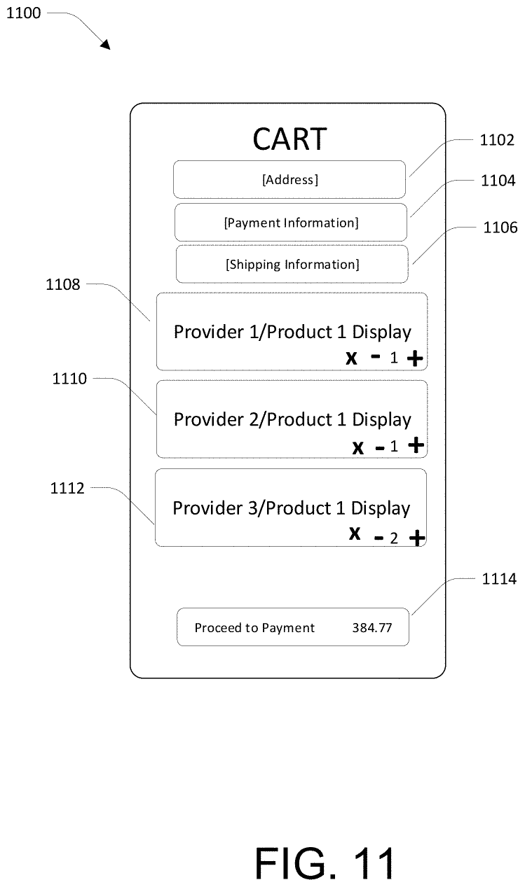

FIG. 11 is an illustration of an example phone interface 1100 depicting a shopping cart that includes products from multiple providers. As previously stated, an advantage of the present techniques is that a single cart may be used to manipulate products from multiple vendors at the same time. After adding products to the cart, a user can update the items by adding or subtracting from the total of products or a user can delete a product altogether.

The example phone interface 1100 includes user personal information 1102 (name, address, etc.), user payment information 1004, and shipping information 1006. These items may be populated from previously stored information or they may be entered by the user. The example phone interface 1100 also includes a Provider 1/Product 1 Display 1008, a Provider 2/Product 1 Display 1010, and a Provider 3/Product 1 Display 1012. More of fewer provider products may be displayed in the interface 1100. In each display, icons allow a user to delete an item, subtract from a total of items, or add to a total of items. This shows how a user can manipulate individual items from various providers in a single shopping cart, providing a great convenience to the user.

The example phone interface 1100 also includes a “Proceed to Payment” button 1014 that displays the total cost of all items in the cart. When actuated, the “Proceed to Payment” button causes personal information 1102 (name, address, etc.), user payment information 1004, and shipping information 1006 to be transmitted to each provider. In an alternate implementation, the system collects the payment from the user and distributes the collected payments according to methods previously described.

### General Operating Environment

The embodiments described herein may be implemented in software that runs on one or more computing devices. The one or more computing devices may be equipped with a communication interface, a user interface, one or more processors, and memory.

The communication interface may include wireless and/or wired communication components that enable the computing device to transmit or receive data via a network, such as the Internet. The user interface may enable a user to provide inputs and receive outputs from the computing device.

The user interface may include one or more data output devices (e.g., visual display, audio speakers), and one or more data input devices. The data input devices may include, but are not limited to, combinations of one or more of keypads, keyboards, mouse devices, touch screens, microphones, speech recognition packages, and any other suitable devices or other electronic/software selection methods.

Each of the processors may be a single-core processor or a multi-core processor. Memory may be implemented using computer-readable media, such as computer storage media. Computer-readable media includes at least two types of computer-readable media, namely computer storage media and communication media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD), Blu-Ray, or other optical storage, magnetic cassettes, magnetic tape, magnetic disk storage or other magnetic storage devices, or any other non-transmission medium that may be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

1. A method, comprising:
displaying a post to a user, the post including an action item;
receiving a user selection of the action item;
retrieving one or more procurement items associated with the action item;
displaying the one or more procurement items;
receiving user information;
receiving an indication from the user to purchase the item;
transmitting the user information to a provider of the procurement item;
receiving a confirmation of purchase from the provider; and
displaying the confirmation of purchase to the user.
